(19) United States
(12) Patent Application Publication
(10) Pub. No.: US 2018/0330574 A1
(43) Pub. Date: Nov. 15, 2018

(54) VIRTUAL GAMING SYSTEM AND METHOD

(71) Applicant: HIGHLIGHT GAMES LIMITED, London (GB)

(72) Inventors: Robert J. Wright, Palm Beach Gardens, FL (US); Stewart James Whittle, Hertfordshire (GB); Timothy Patrick Jonathan Green, Surrey (GB); Angus Wood, London (GB); Chris Latter, London (GB)

(73) Assignee: HIGHLIGHT GAMES LIMITED, London (GB)

(21) Appl. No.: 16/045,609

(22) Filed: Jul. 25, 2018

Related U.S. Application Data
(63) Continuation-in-part of application No. 14/837,644, filed on Aug. 27, 2015.

(30) Foreign Application Priority Data
Sep. 3, 2014 (GB) GB1415586.5

(51) Int. Cl. G07F 17/32

(52) U.S. Cl. CPC G07F 17/3288; G07F 17/323; G07F 17/3211

(57) ABSTRACT

A system has a database that stores a plurality of audio/visual clips. Further, the system has a memory device that has a buffer with a threshold quantity of memory blocks. In addition, the system has a processor that receives the plurality of audio/visual clips in an ordered sequence for a virtual sports game. The processor also writes one or more frames of a first audio/visual clip to the buffer. Further, the processor allocates the threshold quantity of memory blocks such that the processing speed of writing one or more frames of a second audio/visual clip to the buffer is faster than a broadcast frame rate for broadcasting the first audio/visual clip. In addition, the processor writes the one or more frames of the second audio/visual clip to the allocated threshold quantity of memory blocks of the buffer.

### RELATED APPLICATIONS

This patent application is a Continuation-In-Part application of U.S. patent application Ser. No. 14/837,644, filed on Aug. 27, 2015, entitled VIRTUAL GAMING SYSTEM AND METHOD, which claimed priority to GB Provisional Patent Application Serial No. GB1415586.5, filed on Sep. 3, 2014, all of which are hereby incorporated by reference in their entireties.

### BACKGROUND

### 1. Field

This disclosure generally relates to the field of gaming systems. More particularly, the disclosure relates to virtual sports-based gaming systems.

### 2. General Background

Many spectators derive considerable enjoyment from watching or playing a virtual sports (“VS”) game rather than playing an actual sports game; such VS games typically allow users to place wagers on a fictitious sequence of sporting events rather than on live or future sporting events. For instance, an animation of the fictitious sequence is typically generated and displayed on a display screen (e.g., television) so that a user may view, and place a wager on, the animated sequence.

As an example of the aforementioned animation, previous configurations had a console or terminal linked to a database that provided images of a football match in which the image of the ball is removed from the scene of the pitch. A user of the console or terminal was invited to spot-the-ball to predict where the ball is located in the scene of the pitch.

Generating the aforementioned animated sequence is typically a quite resource-intensive process. As a result, conventional configurations for generating VS games based on animated sequences are typically not scalable enough for mass deployment.

### SUMMARY

In one embodiment, a virtual gaming console has a display device. Further, the virtual gaming console has an input device that receives a session initiation input to initiate a virtual game and that receives a challenge response to a challenge presented during the virtual game that corresponds to the virtual game. The challenge is presented via the display device. In addition, the virtual gaming console has a processor, in operable communication with a challenge database and a video clip database storing a plurality of prerecorded video clips of one or more real games. The processor initiates the virtual game based on the session initiation input. Further, the processor determines one or more virtual participants of the virtual game. In addition, the processor determines a subset of the plurality of prerecorded video clips stored in the video clip database. Moreover, the processor allocates a threshold quantity of memory blocks to a buffer. The processor also randomly selects a plurality of virtual game clips from the subset. Further, the processor renders a gapless sequence of the plurality of virtual game clips on the display device. Additionally, the processor determines the challenge from the challenge database. The processor also renders the challenge on the display device and determines an outcome to the challenge response. In addition, the threshold quantity of memory blocks is determined such that the processing speed of writing one or more frames of a video clip to the buffer is faster than a broadcast frame rate for broadcasting an additional video clip.

A computer program product comprising a non-transitory computer readable storage device may have a computer readable program stored thereon. The computer readable program, when executed on a computer, causes the computer to implement processes associated with the virtual gaming console.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a gaming console that may be used to implement a challenge-based VS game.

FIG. 2 illustrates an example of a screenshot displayed by the video display screen.

FIG. 3 illustrates an example of a screenshot of the video display screen illustrated in FIG. 1 displaying a menu of teams so that the user may select an opposing, second team.

FIG. 4 illustrates an example of a screenshot of the video display screen confirming the selection of the first team and the second team.

FIG. 5 illustrates an example of a screenshot of the video display screen illustrated in FIG. 1 presenting one or more challenges for the VS game.

FIG. 6 illustrates an example of a screenshot of the video display screen illustrating a confirmation of the challenge selections via a confirmation table.

FIG. 7 illustrates an example of a screenshot of a video clip rendered by the video display screen illustrated in FIG. 1.

FIG. 8 illustrates another example of a challenge being posed in a current image of the VS game.

FIG. 9 illustrates a screenshot showing a results table for the VS game.

FIG. 10 illustrates a process performed by the processor illustrated in FIG. 1 to implement the VS game based on archived video footage with corresponding user challenges.

FIG. 11 illustrates the internal components of the gaming console illustrated in FIG. 1.

FIG. 12 illustrates a logical model for the database illustrated in FIG. 1.

FIG. 13 illustrates a block diagram of a system that implements the VS game described herein.

FIG. 14 illustrates an example of the contents of the first database illustrated in FIG. 1.

FIG. 15 illustrates an example of componentry of the gaming engine illustrated in FIG. 13.

FIG. 16 illustrates an example of a pipeline that is utilized to process content for a VS game based on a series of previous skill-based events.

FIG. 17 illustrates a blending configuration in which the processor illustrated in FIG. 1 reads data at a synchronized frame rate.

### DETAILED DESCRIPTION

A virtual gaming system based on archived video footage of previous sports-based events is provided. Rather than generating an animation of fictitious events, which is computationally-intensive and labor-intensive, the virtual gaming system selects pre-recorded, or pre-captured, content to generate a fictitious sequence of events, thereby obviating utilization of inefficient technologies such as motion capture. The user is provided with one or more challenges during playback of the fictitious sequence of events. Further, the user may place wagers on the outcome of the user's response to the corresponding challenge.

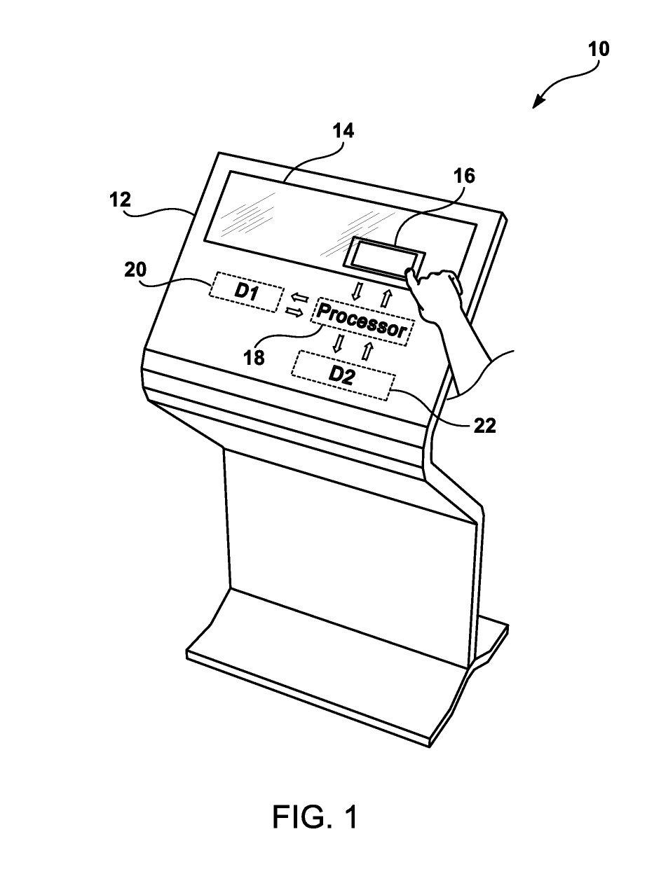

FIG. 1 illustrates a gaming console 10 that may be used to implement a challenge-based VS game. The gaming console 10 may be a machine (e.g., arcade machine, betting slot terminal, video lottery terminal (“VLT”), etc.) that is floor-standing, wall-mounted, or situated in a variety of other ways to provide ease of access to the player. Further, the gaming console 10 may receive a variety of forms of payment (e.g., cash, coin, token, credit card, debit card, virtual currency, etc.).

Further, in one embodiment, the gaming console 10 has a housing 12, which has stored therein a video display screen 14 and a processor 18. Additionally, the processor 18 may be in operable communication (e.g., linked, network access, etc.) with a first database 20 of archived video clips.

In one embodiment, the first database 20 is locally stored within the housing 12; in another embodiment, the first database 20 is remotely located in relation to the housing 12 and communicates via a network (wired or wireless).

In addition, the processor 18 may be in operable communication (e.g., linked, network access, etc.) with a second database 22 of challenges. In one embodiment, the second database 22 is locally stored within the housing 12; in another embodiment, the second database 22 is remotely located in relation to the housing 12 and communicates via a network (wired or wireless). The second database 22 of challenges may be separate from, or integrated with, the first database 20.

As an example, the first database 20 may store archived video footage recorded from a substantial multitude (e.g., hundreds, thousands, etc.) of actual sports-based events (e.g., football, soccer, baseball, hockey, etc.). Further, the actual sports-based events may span across many seasons, or even several years. In addition, the archived video footage may be associated with some, or all, participants (e.g., teams, individuals, etc.) in a particular league or tournament. The archived video footage may be in the form of video clips that are shorter in duration than that of the entire VS event; the reason for the shorter duration is to allow for video clips from a plurality of different sports-based events, whether or not corresponding to the same sport, to be aggregated into a single VS game that is displayed by the video display screen 14.

In one embodiment, the first database 20 stores the archived video clips with metadata or one or more tags, which may store a variety of parameters (e.g., identity of the participant(s), identity of the opponent(s), actual game score, challenge-related attributes of the sports-based event(s), etc.) corresponding to the previous, actual sports-based game. Moreover, the archived video clips may correspond to portions of the sports-based games that would be considered by spectators to be the most interesting, such as the run-up-to, or act of, scoring a goal. Further, such portions of the actual, sports-based games may be the most suitable to present to the user for corresponding challenges, or side challenges, during the VS game.

Additionally, the housing 12 may have stored therein a touch-screen interface 16 that allows a user to perform a variety of tasks (e.g., providing game selections, submitting game wagers, responding to challenges, etc.). For example, the video display screen 14 may be the display screen on the user's electronic media device (e.g., smartphone, tablet device, personal digital assistant (“PDA”), laptop computer, personal computer, etc.). Alternatively, one or more physical input actuators (e.g., buttons, dials, etc.) may be, at least partially, connected to the exterior of the housing 12 to allow the user to provide inputs to perform the tasks.

Although the gaming system console 10 is illustrated with various integrated componentry (e.g., processor 18, display screen 14, etc.), a variety of devices may be used instead of a single console. For instance, a set-top box may store the processor 18 and operably communicate (e.g., via wired or wireless connection) with the display screen 14 (e.g., television, monitor, etc.). The set-top box may then remotely, or locally, communicate with the first and second databases 20 and 22. For example, a television screen may be situated such that a user may use an input/output (“I/O”) device (e.g., smartphone, remote control, smart glasses, etc.) to provide inputs to the set-top box, which may or may not be obstructed from the view of the user. Accordingly, in an alternative embodiment, the databases 20 and 22 may be remotely located from the gaming console 10 and accessed via a network (local or remote). Further, the processor 18 may be stored in the gaming console 10, a set-top box in operable communication with the gaming console 10, a mobile computing device in operable communication with the gaming console 10, and/or a remotely-located server in communication with the gaming console 10.

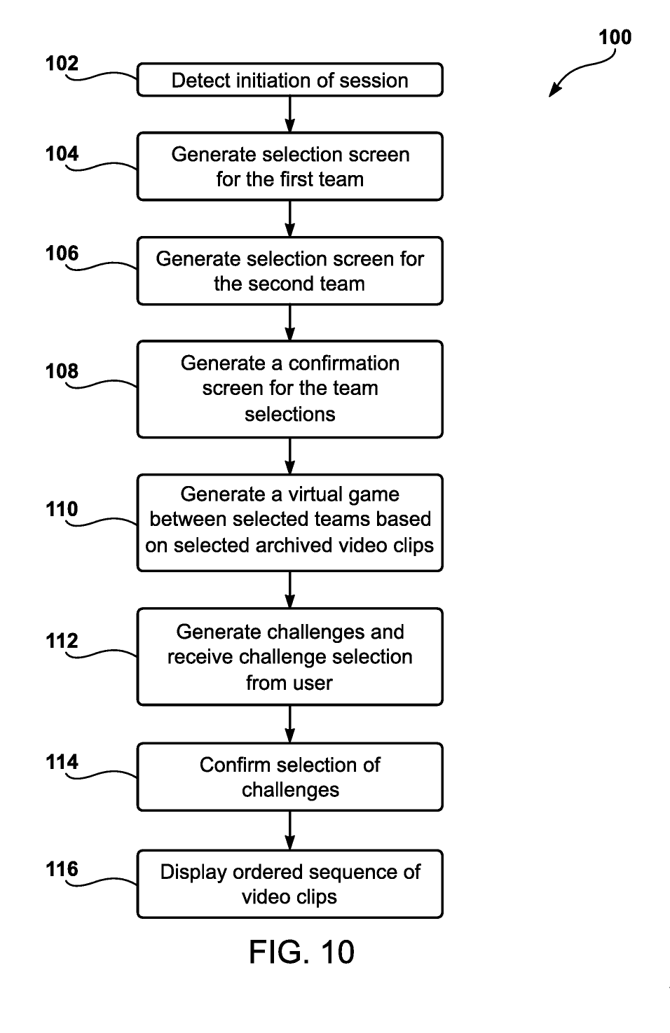

Turning to FIG. 10, a process 100 is performed by the processor 18 illustrated in FIG. 1 to implement the VS game based on archived video footage with corresponding user challenges. At a process block 102, the process 100 detects initiation of a VS game at the gaming console 10 (FIG. 1). For example, the processor 18 may detect when a user inserts a coin, token, or other form of payment into the gaming console 10. Alternatively, the processor 18 may detect when the user has provided some other form of credit (e.g., customer reward points) for game play.

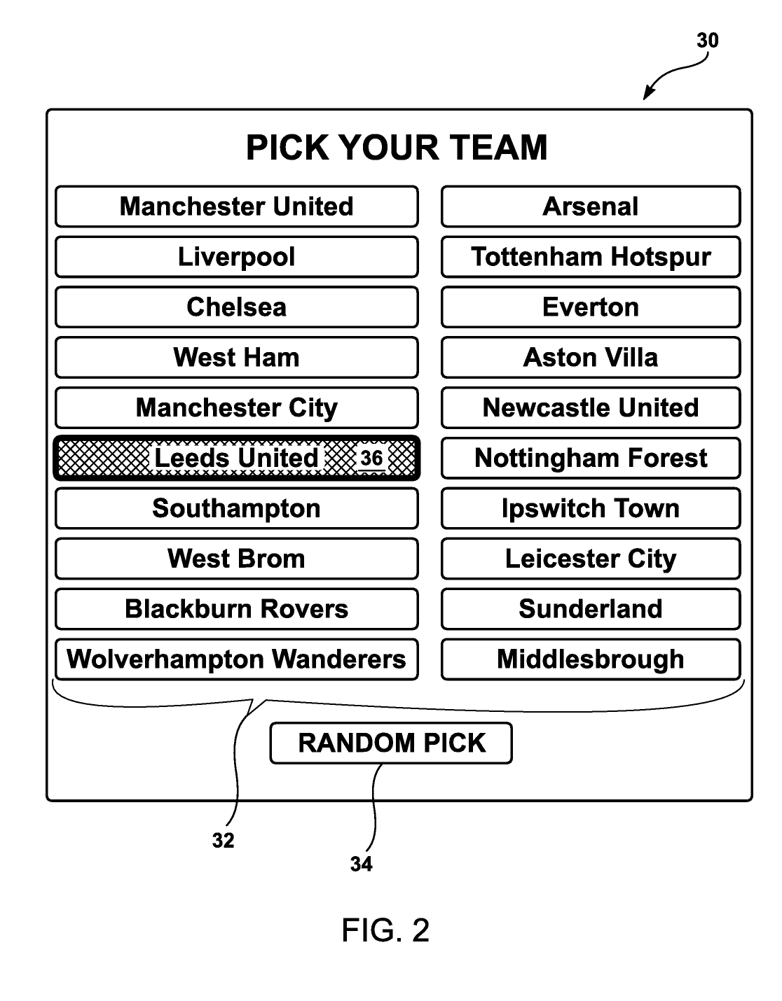

The process 100 then advances to a process block 104, at which the processor 18 generates one or more selection screens at the video display screen 14 illustrated in FIG. 1. For instance, the one or more selection screens may display various menus for selecting a first team, or first individual. FIG. 2 illustrates an example of a screenshot 30 displayed by the video display screen 14 at the process bock 104 (FIG. 10); in this example, a plurality of teams 32 are displayed so that the user may provide an input (e.g., a touch screen input via touch screen interface 16 (FIG. 1), a physical button input, a smartphone/remote control input, etc.). The team 36 is illustrated as being selected by the user. Alternatively, the user may select a random pick indicium 34 to allow the processor 18 to select the first team in the VS game.

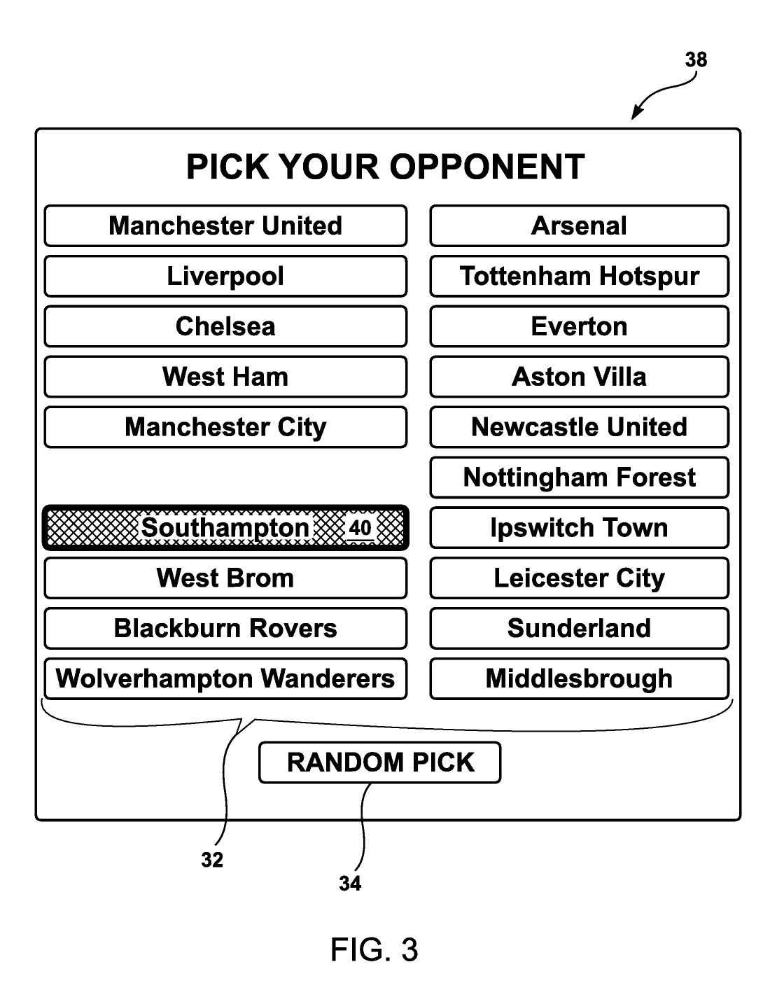

Additionally, again turning to FIG. 10, the process 100 advances to a process block 106, at which the processor 18 generates one or more selection screens that may display various menus for selecting an opposing, second team, or second individual. FIG. 3 illustrates an example of a screenshot 38 of the video display screen 14 illustrated in FIG. 1, and generated at the process block 106, displaying a menu of teams so that the user may select an opposing, second team. For example, the screenshot 38 illustrates the teams that remain after the selection of the first team illustrated in FIG. 2 (i.e., an empty slot for the first team 36 selected in the screenshot 30 appears in the screenshot 38); in this example, the second team 40 is illustrated as being selected—either by the user or by a selection of the random pick indicium 34 by the user. In an alternative embodiment, the first team is selected by the user, and the opposing, second team is selected by a different user.

In yet another embodiment, the selection of the second, opposing team may not be limited to a single team. For example, the user may select “the rest” for the second, opposing team. The processor 18 may then randomly select video clips of all, or some of all, of the remaining teams other than the selected first team. As a result, the processor 18 may select video clips between the selected first team and a variety of other opposing teams for an aggregated set of video clips in the VS game.

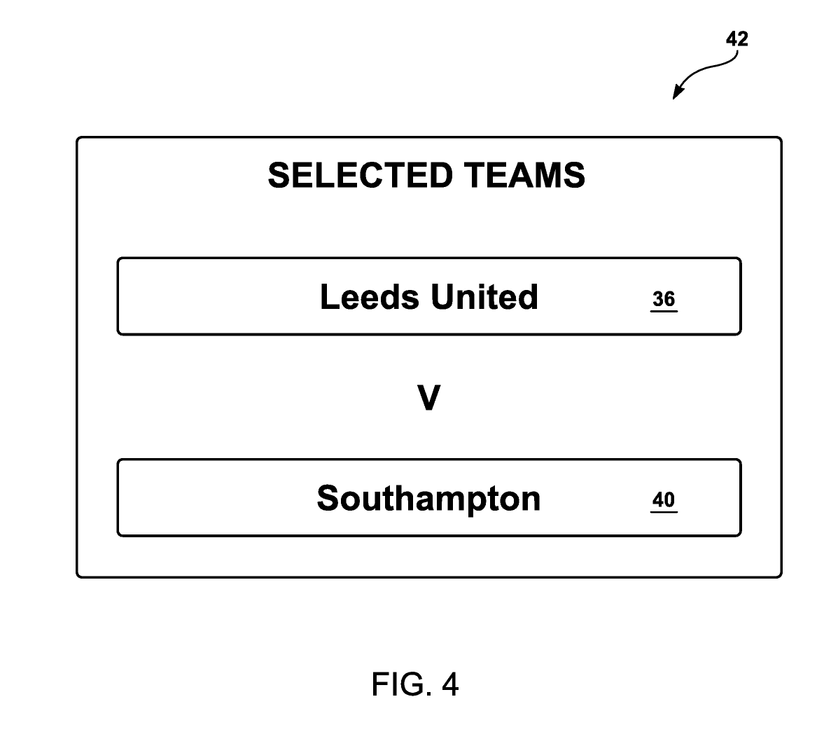

Optionally, the process 100 may then advance to a process block 108, at which the processor 18 generates a confirmation screen displayed by the video screen 14 (FIG. 1) to illustrate the selected first team and opposing, second team. FIG. 4 illustrates an example of a screenshot 42 of the video display screen 14 illustrated in FIG. 1 confirming the selection of the first team 36 and the second team 40. The user may provide a confirmation input or may modify the selected teams.

Further, instead of having different screens for each selection, a single selection screen may be used to allow the user to provide selections for both the first team and the second team. Additionally, the confirmation screen may be integrated with the team selection screens.

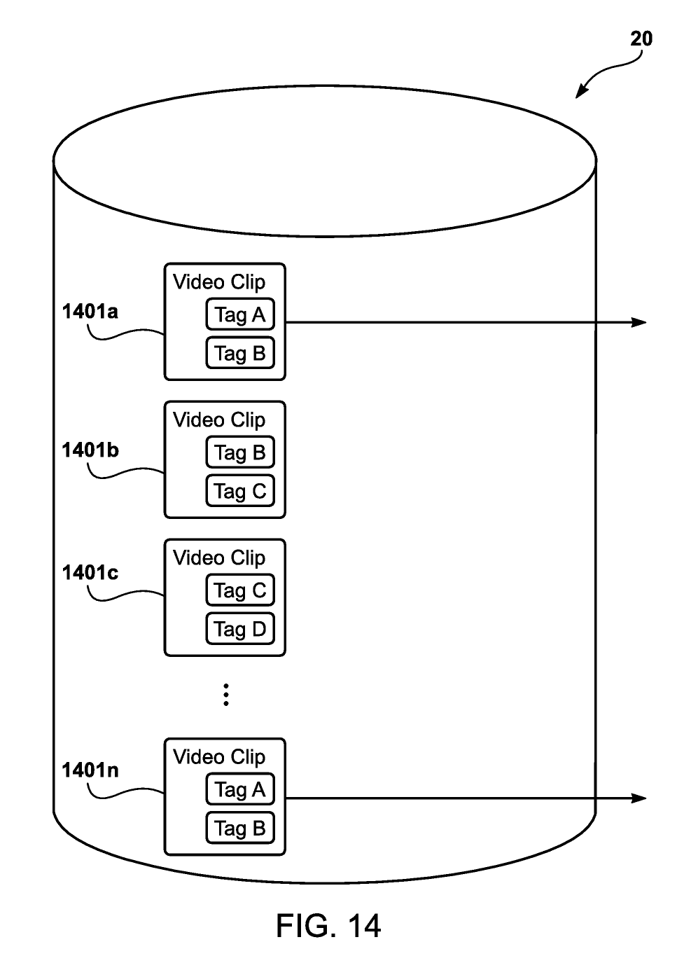

The process 100 then advances to a process block 110, at which the processor 18 selects archived video clips, from the first database 20 (FIG. 1), between the selected first team and the selected opposing, second team. FIG. 14 illustrates an example of the contents of the first database 20 illustrated in FIG. 1. The database 20 may store a plurality of video clips 1401a-n, each being stored with a first tag for a first team and a second tag for a second team that played in the corresponding actual sports-based game. The processor 18 may select only the video clips that have both a tag for the first selected team (e.g., “Tag A”) and a tag for the second selected team (e.g., “Tag B”). Searching via such tags improves the search time of a computing device that obtains the video clips for inclusion into the VS game.

Given that the search results may include a significant quantity of video clips (e.g., hundreds, thousands, etc.) corresponding to historical games between the first selected team and the second, opposing team, the processor 18 may randomly select from the search results a set of video clips corresponding to the first team and the second, opposing team. Accordingly, the processor 18 uses a data model that tags video clips for improved search times to improve the functioning of a computer.

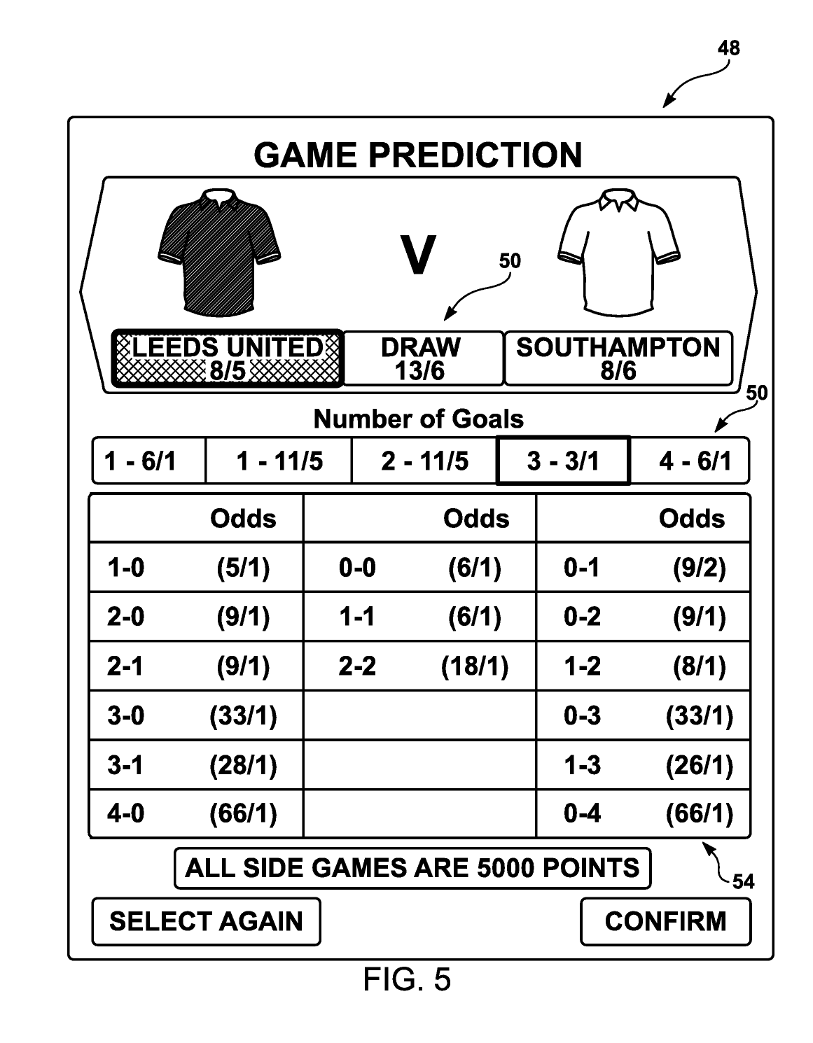

Additionally, the process 100 advances to a process block 112 to generate one or more challenges during the VS game. FIG. 5 illustrates an example of a screenshot 48 of the video display screen 14 illustrated in FIG. 1 presenting one or more challenges for the VS game. For example, a goal score challenge table 54 allows a user to attempt to predict the goal scores for the teams participating in the VS game. As another example, a total score indicium 52 allows a user to attempt to predict the total number of goals scored. As yet another example, a team win indicium 50 allows a user to attempt to predict which team wins the VS game. Various other types of challenges may be based on other factors (e.g., attendance, month, featured player, commentator, saves, misses, tackles, crowd scenes, fouls, referee decisions, cards awarded, etc.). The challenges may be associated with a previous, current, or subsequent video clip in relation to the video clip being viewed by the user. Further, the challenges may be based on the substance of the actual, sports-based game that occurred, venue, actual spectators, sports-based game player facts (e.g., biographical information), social gaming competition (i.e., other VS-based game user statistics, current points, etc.) in relation to other users of the VS-based game that may interact with the user via a social networking platform, etc.

The challenges are based on the selection, and arrangement (i.e., ordering) of, the video clips. In other words, the first selected team may have had a historically higher total number of goals against the second selected team over many years but may have a lesser total number of goals in the VS game based on the video clip selection (i.e., a subset of the total number of goals).

The screenshot 48 may also display various odds of winning (e.g., bookie odds, decimal odds, etc.). As a result, the user is able to participate in a gambling experience that is similar to gamblers betting on real live events. The user may provide various predictions via the touch screen interface 16 illustrated in FIG. 1 or other input device.

In one embodiment, the challenges and the corresponding responses are selected by the user. In other words, the user is able to select one or more challenges from a variety of possible challenges and then provide a prediction based on the selected challenge(s). In another embodiment, the challenges are automatically selected by the processor 18 (FIG. 1) for the user. For instance, the processor 18 may select the challenges based on a user profile, which provides various challenge selection criteria most suitable to the user (e.g., user interests, previous user challenges, etc.).

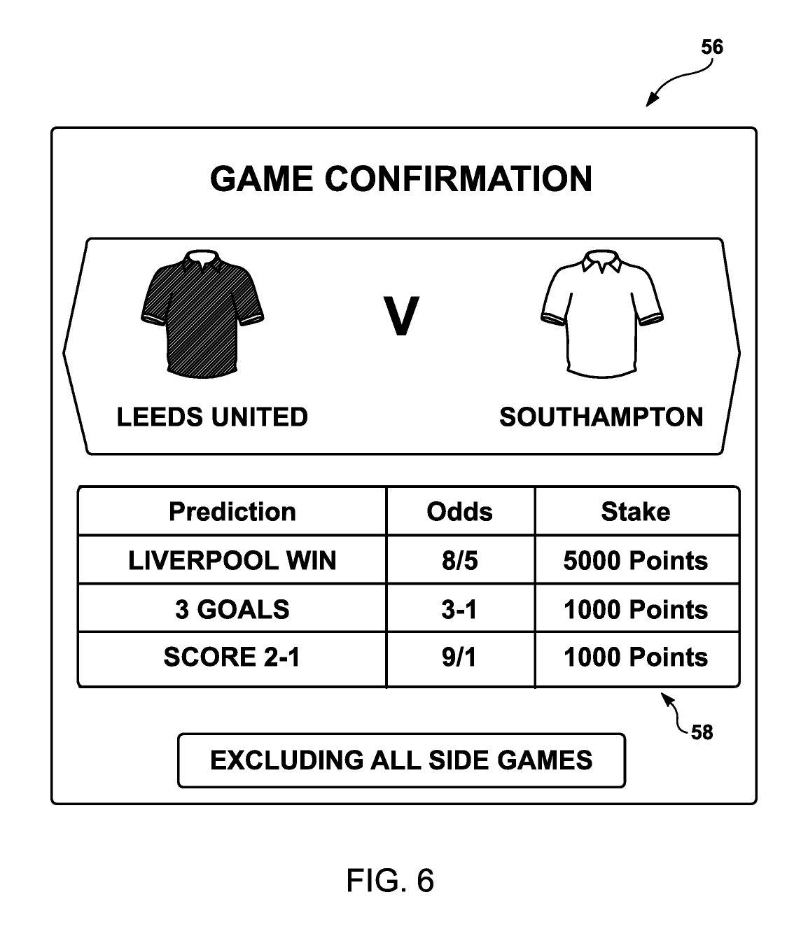

Optionally, the process 100 may advance to a process block 114 to confirm the selection of the challenges and user responses illustrated in FIG. 5. Accordingly, FIG. 6 illustrates an example of a screenshot 56 of the video display screen 14 illustrating a confirmation of the challenge selections via a confirmation table 58; in this example, the user's challenge responses are presented in the confirmation table 58 alongside the challenges prior to the processor 18 initiating rendering of the selected video sequence on the video display screen 14.

Subsequently, the process 100 advances to a process block 116 to display an ordered sequence of individual video clips from archived video footage of actual sports-based events stored in the first database 20 (FIG. 1). The ordered sequence of the individual video clips forms the basis of the VS game.

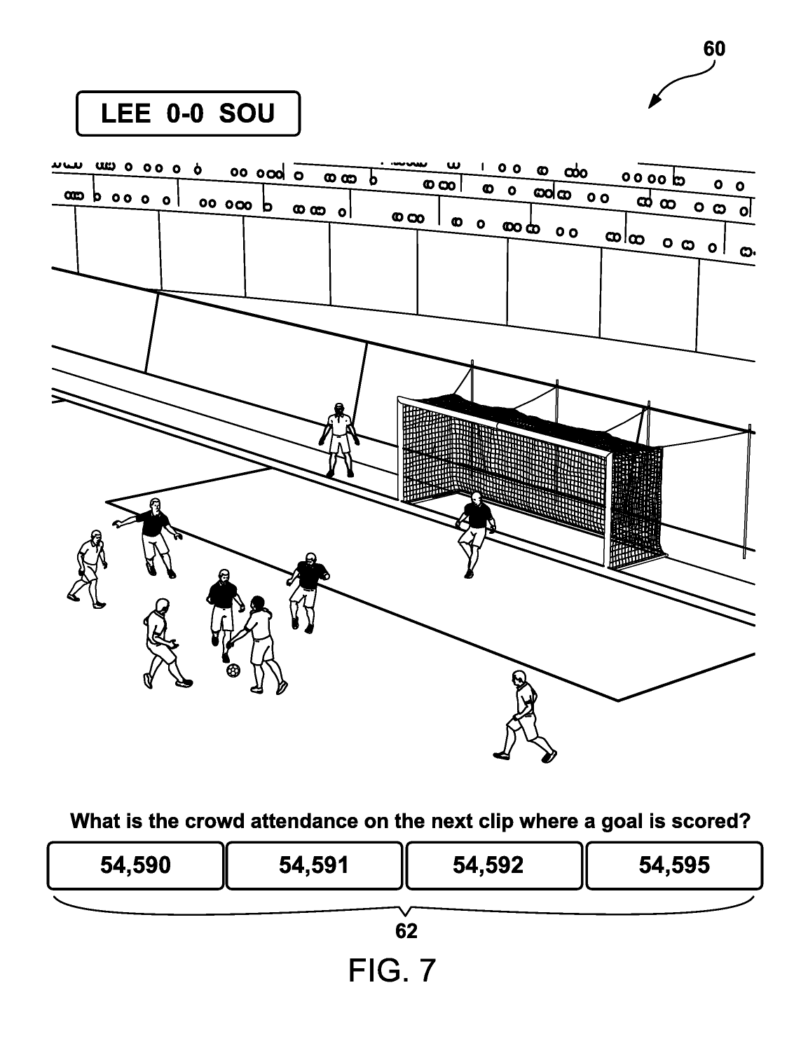

FIG. 7 illustrates an example of a screenshot 60 of a video clip rendered by the video display screen 14 illustrated in FIG. 1. As illustrated, FIG. 7 includes an optional feature: the provision of a subsidiary challenge/side wager 62 in which the processor 18 invites the user to predict a further attribute of the sports-based event being displayed; in this instance, the challenge refers to a subsequent image in the video clip to appear, not the current the current image illustrated in the screenshot 60 of the video clip. In one embodiment, the further attribute is associated with a remainder of the video clip yet to be shown. In the example illustrated by FIG. 7, the challenge being posed is for the user to predict the attendance at the sports-based event. The challenge may be chance-based or skill-based (i.e., allowing the user to exercise observational skill to attempt to accurately assess or predict a response to the challenge).

In one embodiment, the user is provided with a variety of answers to choose from in a challenge response menu 62 (e.g., multiple-choice format) displayed in the current image illustrated in the screenshot 60 of the video clip. In another embodiment, the user is provided with a data input field in which the user may manually provide a customized answer. The processor 18 may then determine that the user has correctly answered the question, or has provided a guesstimate within an acceptable threshold (e.g., within a predetermined percentage of deviation from the exact answer).

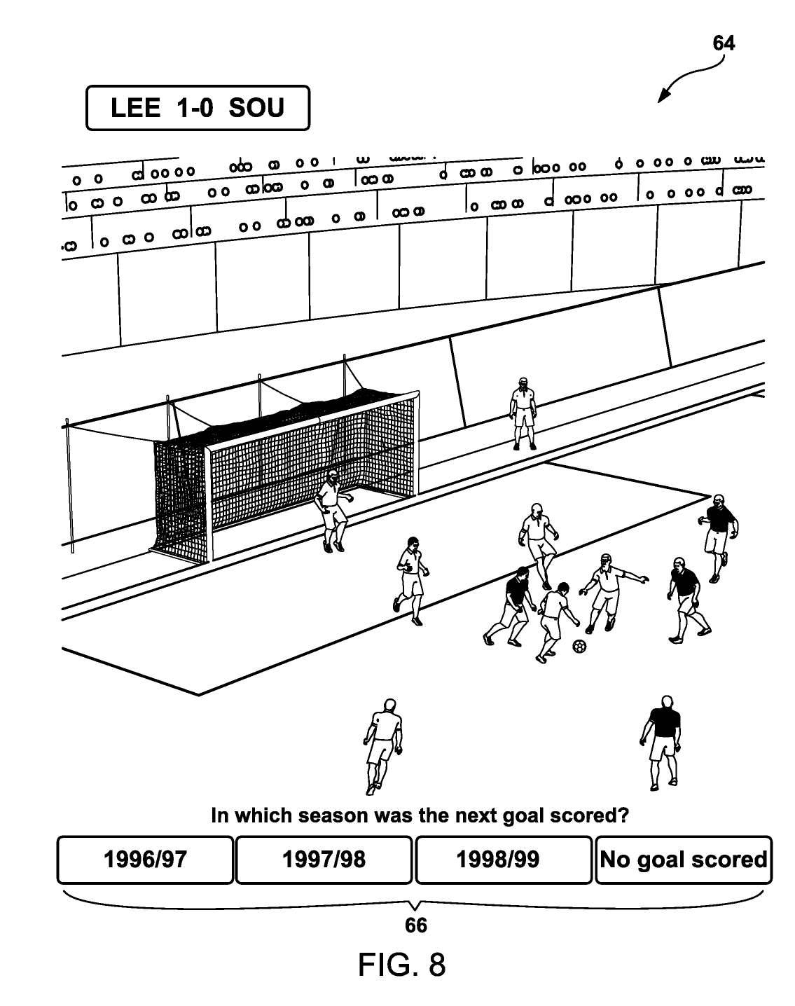

FIG. 8 illustrates another example of a challenge being posed in a current image of the VS game. For instance, a screenshot 64 may include a current image of a sports-based event such as a soccer match. Instead of the challenge being based on a subsequent image in the video clip, the challenge may be non-image based (e.g., based on historical knowledge of the teams). For example, the screenshot 64 illustrates a challenge that tests the knowledge of the user by challenging the user to identify the soccer season in which the game displayed by the screenshot 64 took place. The user may then select an answer from an answer menu 66 or may provide a customized input.

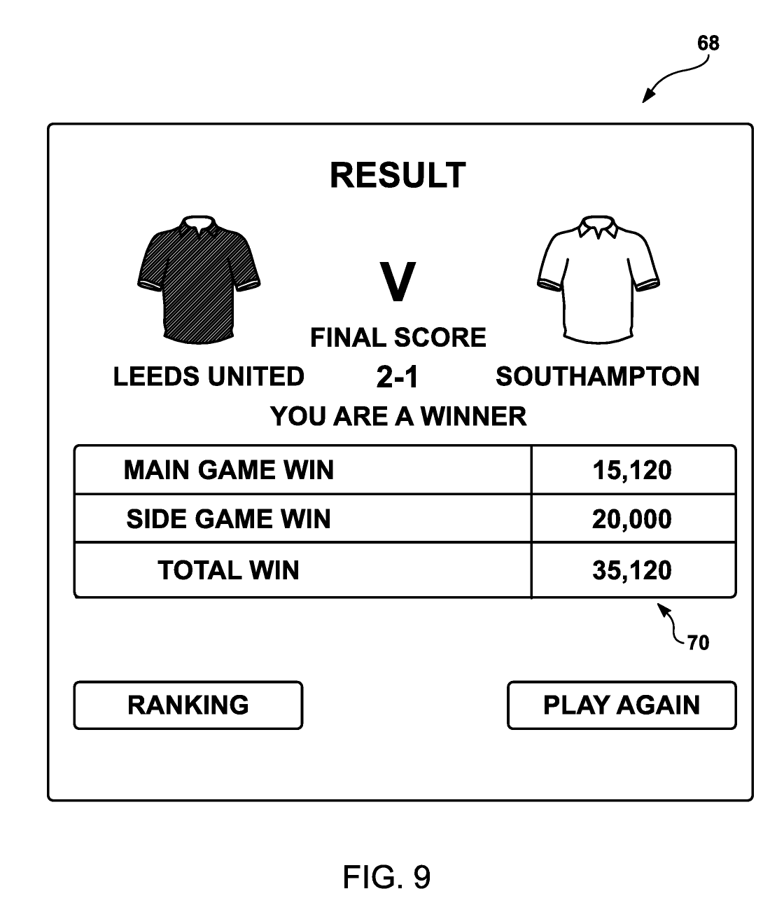

Further, FIG. 9 illustrates a screenshot 68 showing a results table 70 for the VS game. For example, the results table 70 may include the final score between the teams and the scores achieved by the user in the challenge(s); in this example, the user is shown as having won fifteen thousand one hundred twenty credits from correct predictions of the main game challenges and an additional twenty thousand credits from the subsidiary challenges. The screenshot 68 provides an example of how a user may win a prize amount associated with the credits based on a wager. Further, the amount of credits may be for social gaming purposes (i.e., not being associated with any monetary amount, but rather playing for kudos).

The user's experience of using the gaming console 10 may be based on freeplay, freemimum play, virtual currency, gambling play with payouts, social play with and/or against other users (online or offline). The user can play for rewards that are monetary rewards or credit rewards (e.g., credits for extended gameplay, extra game levels, or other collectibles. Alternatively, the player can play for the kudos of a high score or beating one or more competitors/opponents. Further, the gameplay may be structured as a fantasy league using various combinations of the first team and the second team. League tables and/or chat room functionality may be incorporated into the fantasy league. For example, players may be able to chat with one another via a chat room feature. The players may exchange comments about football gossip, predictions about games, game tournaments, and/or leader boards—even during game play.

The VS game described herein may also take the form of a tournament. For example, a user may select a team that is then opposed by a team selected by another player. A trophy style version of the VS game would result in teams being eliminated to produce an overall winner.

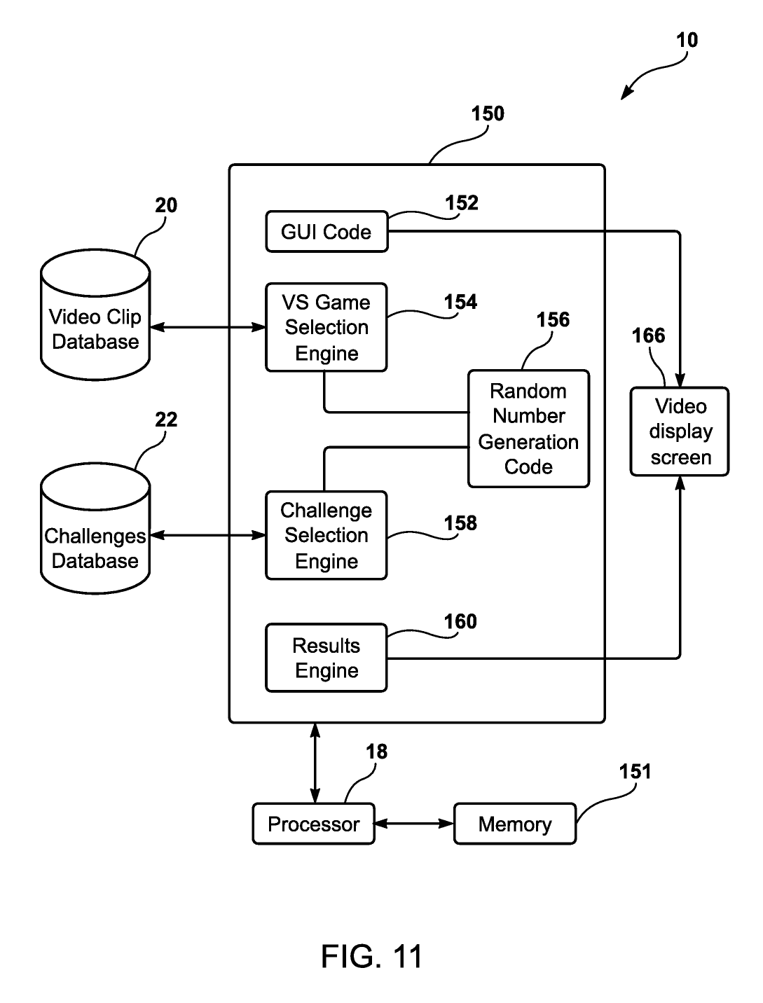

Turning to FIG. 11, the internal components of the gaming console 10 (FIG. 1) are depicted. The processor 18 communicates with a data storage device 150 that may be stored locally within the gaming console 10, external to the gaming console 10 via a network or one or more wires, or remotely via a server in operable communication with the gaming console 10 via a network. The processor 18 may retrieve various components from the data storage device 150 for execution in a memory device 151.

For instance, the data storage device 150 may store graphical user interface (“GUI”) code 152 that is configured to display a GUI for receiving at least one team, or individual, selection input and at least one challenge input. The processor 18 may execute the GUI code 152 and render the GUI at the video display screen 14 illustrated in FIG. 1.

Further, the data storage device 150 may store random number generator code 156 that may be used by various engines to facilitate operation of the VS game. For example, the processor 18 may use a random number generator (“RNG”), according to the random number generation code 156, in conjunction with a VS game selection engine 154 that is also stored by the data storage device 150. The VS game selection engine 154 allows the processor 18 to select various participants in the VS game. As discussed with respect to the first database 20 illustrated in FIG. 1, the VS game is selected based upon an aggregation of archived, actual sports-based event footage. The processor 18 utilizes the VS games selection engine 154 in conjunction with the RNG to randomly select archived footage based on one or more tags corresponding to the user-selected, or machine-selected, participants of the VS game.

Additionally, the processor 18 may utilize the RNG in conjunction with a challenge selection engine 158, which is also stored on the data storage device 150. For example, the processor 18 may utilize the challenge selection engine 158 to randomly select one or more challenges from the challenge database 22 to correspond to one or more video clips in the selected VS game.

Moreover, the processor 18 may utilize a results engine 160, which is also stored on the data storage device 150, to generate results data based on whether or not the challenges are met by the randomly selected video clips between the two participants.

In order to implement wagers effectively, the possible challenge answers (e.g., multiple-choice format) may be determined based on a list of outcomes available in the video clips in the database 20; as a result, the player is prevented from learning or researching viable challenge responses. Further, in one embodiment, the processor 18 utilizes a time limit requirement for the player to provide a response to a challenge to further reduce the possibility of the player researching a challenge response. After the player has provided a selection, the processor 18 utilizes the results engine 160 to determine if the wager is won by the player (i.e., the challenge response is correct). The processor 18 may then utilize the results engine 160 to select display imagery and/or text to convey the result of the wager on the video display screen 14.

With respect to the selection of video clips from the database 20, a sequence time duration for the VS game may be selected and concatenated for display until the allotted time plus/minus allowed deviation has been realized. Further, the random selection of the categorized archived video clips may be displayed to a user on demand or at pre-determined time intervals. A database table may contain information about each archived video clip; such information is then accessible by the processor 18, or other processor responsible for rendering the video clips at the video display screen 14. An index number may be assigned to each archived video clip. Further, the database table may contain a record for each archived video clip; the record may contain a pointer to each actual game participant (team/individual) in the VS game, a pointer to the actual sports-based game date, a pointer to significant actions in the video clip, a link to the actual game location, a link to the team home location, the length of the video, the video codec information, the path to the storage location, and the file name as stored at the storage location. Additional tables may contain information about games played, game locations, team names with home locations, player names, and user definable fields.

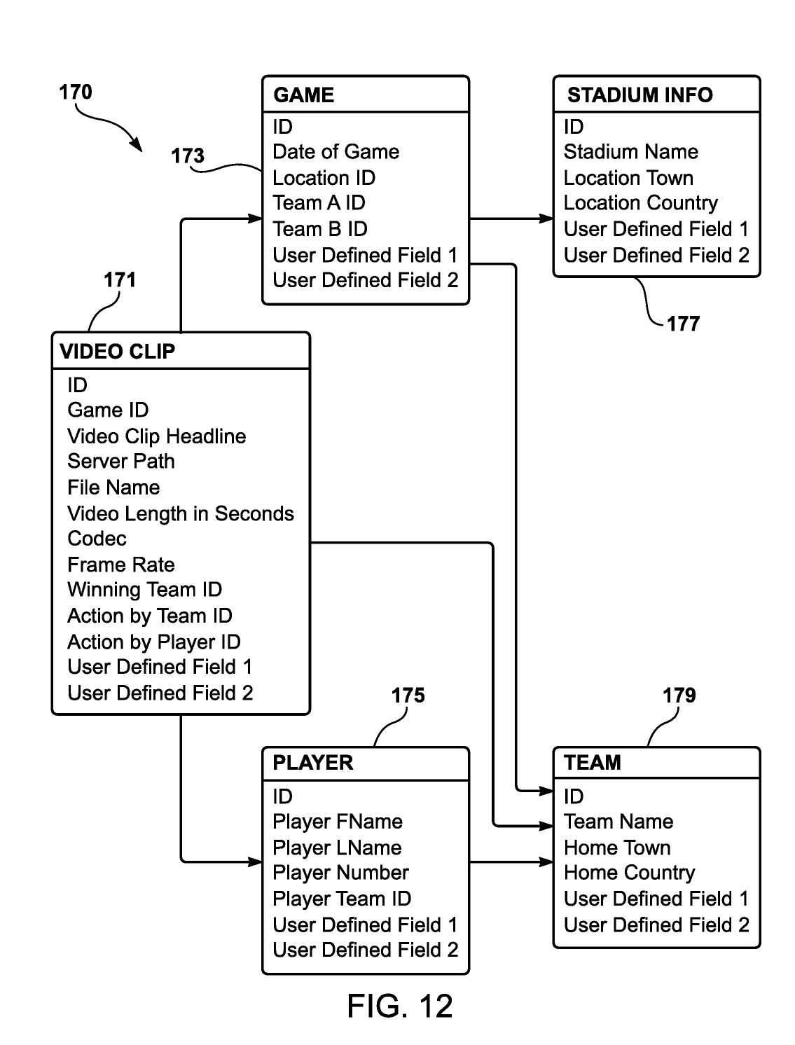

FIG. 12 illustrates a logical model 170 for the database 20 illustrated in FIG. 1. In one embodiment, the selection parameters for one or more video clips are embedded into a SQL select statement and submitted to the database 20. The select statement returns columns including, but not limited to, video clip id, video clip headline, server path, file name, video length in seconds, codec, and frame rate. Further, the database 20 may interact with a predefined schema to maintain and access information for the selection of video clips in addition to associating the one or more video clips with additional information describing the content of the one or more video clips.

As an example, the logical model 170 may include a video clip table 171 that is used to track and maintain the location of the video clip for retrieval. Additional links may point to indexes in other tables to bring in more information for filtering purposes. The video clip table 171 includes, but is not limited to, an identifier, a game identifier, a video clip headline, a server path, a file name, a video length (e.g., in seconds), a codec, a frame rate, a winning team identifier, an action by team identifier, an action by player identifier, a first user defined field, and a second user defined field.

The identifier is the index number of a video clip identifier, which is unique for each video clip and is utilized as part of the randomized selection process. Further, the game identifier is the numeric index identifier of a record stored in the game table. In addition, the video clip headline is a user-defined text description of the video clip. The server path is the connection information used to access the server that contains the actual video clip file(s). Moreover, the file name is the video clip file name as stored by the server. The video length in seconds contains a numeric value describing the time duration of the video clip. Additionally, the coded describes the video display engine utilized to display the video. Further, the frame rate describes the frame that is used for time calculations and coded configuration. In addition, the winning team identifier is the numeric index identifier of the team/participant that won the event in the video clip. The action by team identifier is the numeric index identifier of the team that had significant accomplishments in the video clip. Further, the action by player identifier is the numeric index identifier of the player noted as having significant accomplishments in the video clip. Finally, the first user-defined field and the second user-defined field are used for expansion of functionality or periodic special events requirements.

The logical model 170 may also include a game table 173 that is used to track and maintain game information. The game table 173 includes, but is not limited to, an identifier, a date of the game, a location identifier, a first team identifier, a second team identifier, a first user-defined field, and a second user-defined field. The identifier may be used by the game identifier from the video clip table 170 to link to the correct record in the game table 173. Further, the date of the game is the date on which the sports-based event was played. In addition, the location identifier may be a link to a stadium information table 177. The first user-defined field and the second user-defined field may be links to a team table 179 to identify the teams that played the sports-based game in the video clips. Finally, the first user-defined field and the second user-defined field are used for expansion of functionality or periodic special events requirements.

Moreover, the logical model 170 may also include the stadium information table 177 to track and maintain stadium, or other venue, information. The stadium information table 177 includes an identifier, a stadium name, a location town, a location country, a first user-defined field, and a second user-defined field. The identifier is used by the game table 173 to identify the location at which the game was played. Further, the stadium name, or other venue name, is the official name of the stadium, or other venue. Additionally, the location name is text describing a town, city, province, or other demarcated area that indicates the location of the stadium, or other venue. The location country is text describing the country in which the stadium is located. Finally, the first user-defined field and the second user-defined field are used for expansion of functionality or periodic special events requirements.

Moreover, the logical model 170 may also include a player information table 175, which may be used by the video clip table 171 to identify the player of note in the video clip. The player information table 177 includes, but is not limited to, an identifier, a player first name field, a player last name field, a player number, a player team identifier, a first user-defined field, and a second user-defined field. The identifier is used by the video clip table 170 to identify the player of note (e.g., the player that scored a goal). Further, the player first name field contains text describing the player's first name, and the player last name field contains text describing the player's last name. Moreover, the player number field contains text describing the uniform number of the player. In addition, the player team identifier contains a numeric identifier for the team linking to the team table 179 to identify an associated player. Finally, the first user-defined field and the second user-defined field are used for expansion of functionality or periodic special events requirements.

The logical model may also include the team table 179, which is used to track and maintain team information. The team table 179 includes, but is not limited to, an identifier, a team name, a home town, a home country, a first user-defined field, and a second user-defined field. The identifier is used by the video clip table 171, the game table 173, and the player information table 175 to identify team(s) associated with each record. The team name field contains text that describes a team name, the home town name field contains text that describes the home town, city, province, or other demarcated area of the team, and the country field describes the country in which the team's home town, or other geographic area, is located. Finally, the first user-defined field and the second user-defined field are used for expansion of functionality or periodic special events requirements.

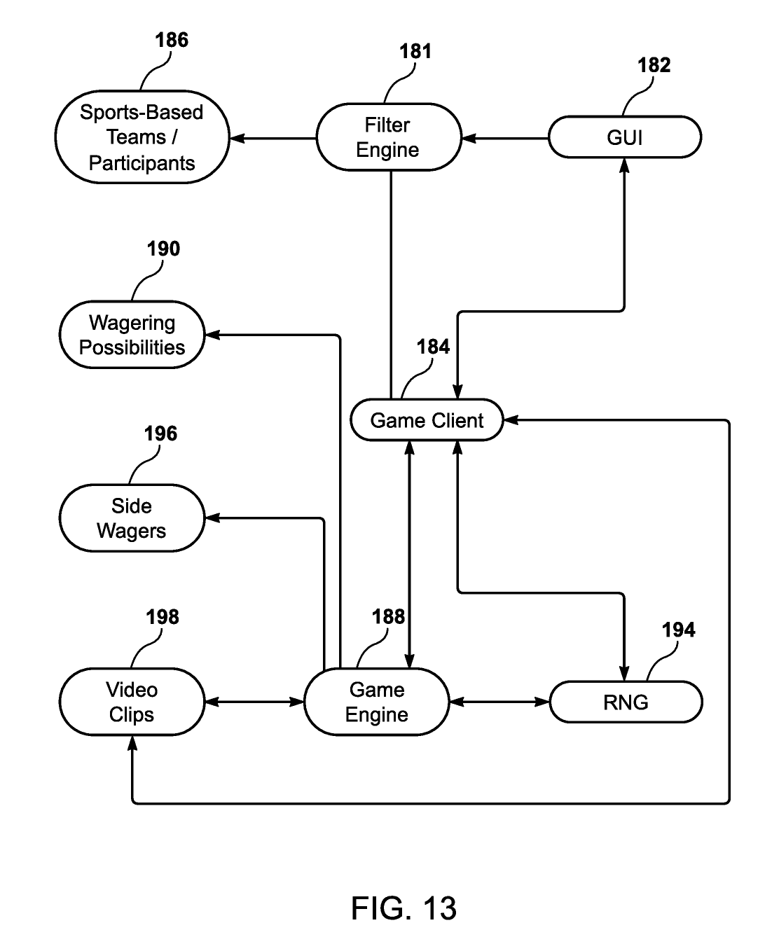

FIG. 13 illustrates a block diagram of a system 180 that implements the VS game described herein. The system 180 may be stored on a data storage device, memory device, etc. for execution by the processor 18 illustrated in FIG. 1. A GUI 182 is used to set parameters to obtain the display of video clips within user-defined guidelines. The final results are displayed to the user in a video format.

Further, the game client 184 may include some, or all, of the graphical and video information that is supplied to the user. The game client 184 may use a filter engine 181 to select sports-based teams/participants 186. Additional filtering may be imposed based on game date, location, player, or a user-defined field. The database fields are displayed at the GUI 182 for menu selection (e.g., via pull-down menus) so that the user may select filter parameters and have a real-time view of the available parameters from which to select.

In addition, the game client 184 communicates with a game engine 188 to provide the game engine 188 with the user team selections. The game engine 188 provides various wagering possibilities 190 based on the team selection parameters and transfers that information to the game client 184. Further, the game client 184 displays the wagering possibilities to the user via the video display screen 14 illustrated in FIG. 1. The wagering possibilities 190 are not limited to one request and may be expanded to include side wagers 196. For example, the side wagers 196 may be provided at the start of the VS game, or during game play of the VS game. The side wagers 196 may be based on challenges (e.g., questions) selected from the challenges database 22 (FIG. 1); such challenges may be linked to tags, or metadata, in the video clip database 20 that are attached to each unique video clip. After the wager is confirmed, the game client 184 communicates with an RNG 194, which provides a game result.

In one embodiment, the game client 184 is not limited to maintaining the same wager/side wager through a VS game. For example, the game client 184 (e.g., computing device for online game play, mobile device for local game play or online game play, etc.) may allow the user to change a wager/side wager during a video clip corresponding to the wager or during a subsequent video clip even though the wager was for the previous video clip. The user may also pause the video clip sequence and re-wager based upon the position in the VS game at which the VS game has been paused. In other words, subsequent events (e.g., additional goals, player injuries, etc.) in the sequence of video clips may provide an impetus for the user to want to modify a previously placed wager.

In another embodiment, the game client 184 (e.g., computing device for online game play, mobile device for local game play or online game play, etc.) may allow the user to skip a result at any time during the VS game. In yet another embodiment, the game client 184 (e.g., computing device for online game play, mobile device for local game play or online game play, etc.) may allow the user to cash out during play of the VS game. In other words, the user may obtain a prize(s) won from corresponding wagers at various points in the VS game without viewing the VS game until completion.

After generating the game result, the RNG 194 transfers the game result to the game engine 188, which may have one or more predetermined parameters for the sequence length of the video clips in the VS game; the sequence length may be varied and customized but will have at least two video clips. The maximum video display time is a fixed value (e.g., measured in seconds). When a video clip is selected, the video length of that video clip is added to the total current run time of the current video clip sequence. A selection (e.g., random) is performed for subsequent video clips until no more video clips may be fit within the sequence length. Accordingly, the resulting sequence may have a total time that is less than or equal to the predetermined maximum video display time.

In one embodiment, the game engine 188 may utilize a turbo play variation to reduce a size of a video clip to encapsulate a significant action (i.e., an event that determines the outcome of the video clip). For example, if the maximum video display time is not reached but also does not allow for a next randomly selected video clip having a particular time length, the game engine 188 may remove the non-significant action portions of the video clip (i.e., prior to and/or after the significant action) so that the modified video clip has a time length that comports with the maximum video display time. Accordingly, rather than expanding the maximum video display time to accommodate for another video clip, which would increase memory requirements, the game engine 188, as executed by the processor 18 (FIG. 1), reduces the size of the video clip to reduce memory requirements for rendering of the additional video clip. The game engine 188 may send such information to the game client 184 so that the game client 184 renders the contracted, additional video clip rather than the entire, additional video clip; the functioning of a computer is thereby improved.

The game client 184 also controls selection of video clips 198 based upon data received from the game engine 188, as determined by the RNG 194. In other words, the RNG 194 determines the VS game outcome, and the game engine 188 then selects (i.e., possibly with use of the RNG 194) video clips that match the VS game outcome. The game client 184 then obtains the corresponding video clips from the video clip database 20 (FIG. 1).

The game client 184 and/or game engine 188 may utilize a buffer in a memory device. For instance, if pre-recorded data such as video clips was sent to a computer, those video clips would have typically been streamed simultaneously to the computer for playback with gaps between the video clips rather than the gapless playback performed by the gaming client 184 and/or game engine 188. Instead of having memory requirements for simultaneously receiving streamed video clips, the virtual gaming system obtains gapless playback by decoding frames in a pipeline. Through utilization of a buffer in a memory device, the virtual gaming system improves the functioning of a computer for non-animated sequences by reducing memory requirements.

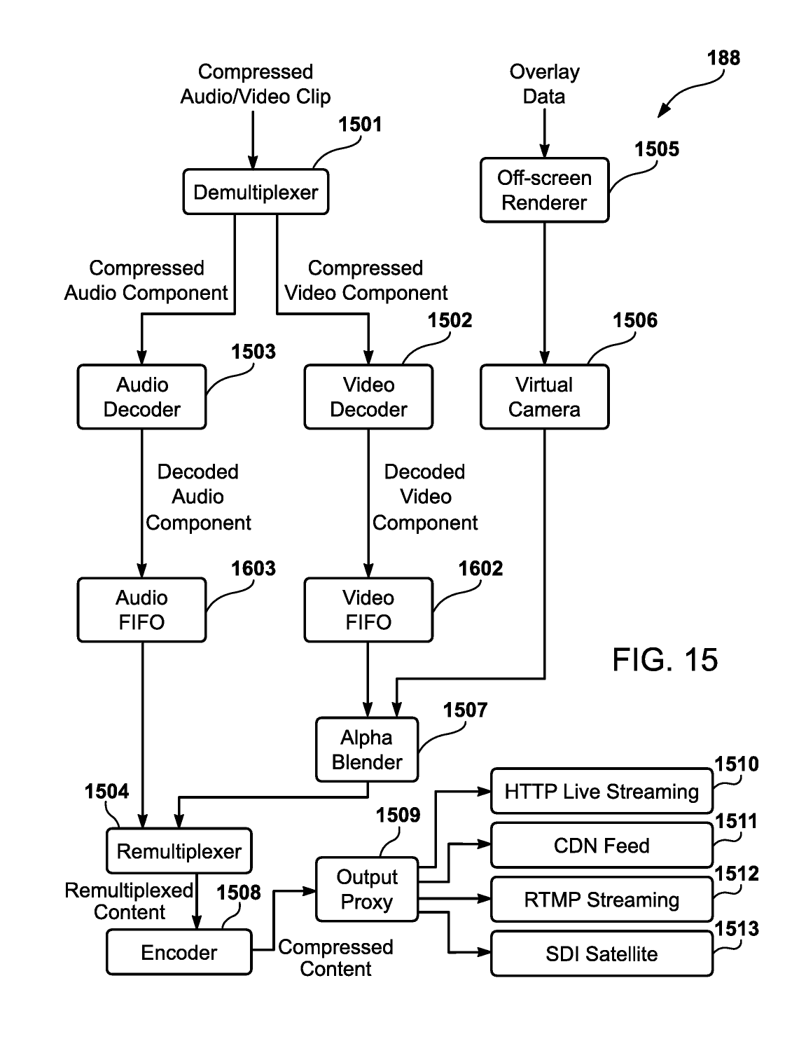

FIG. 15 illustrates an example of componentry of the gaming engine 188 illustrated in FIG. 13. The processor 18 (FIG. 1) receives a plurality of compressed video clips from the video clip database 20. In one embodiment, the processor 18 may compose a queue of video clips (e.g., in the order received). The processor 18 may compose the rendering data based on each video clip in turn.

For instance, a compressed video clip that is at the front of the queue may be provided by the processor 18 to a demultiplexer 1501, which demultiplexes the compressed video clip into its compressed video components and compressed audio components. The processor 18 provides the compressed audio component to an audio decoder 1503, which decodes the compressed audio component into its uncompressed audio format, and the compressed video component to a video decoder 1502, which decodes the compressed video component into its uncompressed video format.

In one embodiment, the uncompressed video component is added to a first-in, first-out (“FIFO”) video queue, and the audio component is added to a FIFO audio queue that is distinct from the FIFO video queue. (The FIFO queues may be stored in a memory device, data storage device, or another non-transitory computer readable storage device.) Whereas the current decoded video component outputted from the FIFO video queues is processed via the processor 18, the current decoded audio component, as determined by first positioning in the FIFO audio queue, is not processed until the processing of the decoded video component has completed.

In other words, an audio/video clip is decomposed into its respective audio and video components (e.g., frames) to isolate the video component for processing individually from the audio component. After enhancing the video component, the processor 18 may utilize a re-multiplexer 1504 to recompose an audio/video clip with the original audio component and the enhanced video component.

As the end of a video component is about to be read by the processor 18, the next video component from the FIFO video queue is retrieved. Accordingly, the FIFO video queue allows for enough buffering so that uncompressed video frames being subsequently read by the processor 18 are not completely consumed before the video decoder begins decoding uncompressed video frames of the next A/V clip.

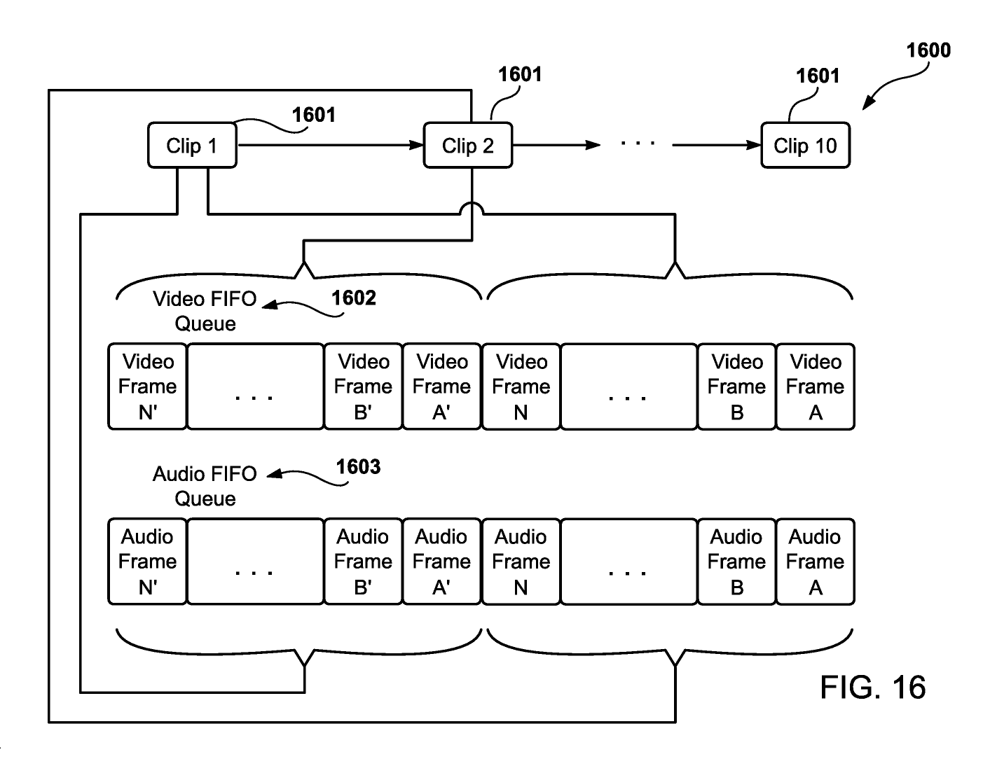

FIG. 16 illustrates an example of a pipeline 1600 that is utilized to process content for a VS game based on a series of previous skill-based events. For instance, a plurality of audio/video (“A/V”) clips 1601, each corresponding to a previous skill-based event occurring prior to initiation of the VS game, may be played back-to-back in a certain order for the VS game. Audio and video FIFOs are generated for each of the A/V clips 1601. As an example, a video FIFO queue 1602 for a first clip 1601 has video frame A in the first position since video frame A is the first frame of the first clip 1601, and an audio FIFO queue 1603 for the first clip 1601 has the audio frame A in the first position since audio frame A is the first frame of the first clip 1601. Prior to decoding the last video frame N in the video FIFO queue 1602, the processor 18 (FIG. 1) ensures that enough of a buffer is present in a memory device to allow the video decoder (FIG. 2) to write decompressed video frames from a second clip 1601 to the memory device. For instance, as the video decoder 1602 is about to decode a last video frame N from the first video FIFO queue 1602, the processor 18 frees up memory that was previously occupied by video frames A through N of the first video FIFO queue 1602; as a result, the memory device has enough of a buffer for video frame A′ of a second video FIFO queue. A threshold quantity of memory blocks may be allocated to the memory device to write the video frame A′ to the buffer faster than the broadcast frame rate (e.g., twenty five frames per second for high-definition content) of the video frame N. Therefore, playback appears to the user as being gapless (e.g., no gap appears between the first clips 1601 and the second clip 1601 during playback).

By performing effective memory management, the processor 18 illustrated in FIG. 1 reduces memory requirements to improve the functioning of a computer. As A/V clips may exhaust large quantities of memory, conventional, simultaneous storage of A/V clips is ineffective for VS games (i.e., gaps between clips would result as too much memory from a current clip would consume memory necessary for a next clip). The pipeline 1600 avoids the necessity of such significant memory requirements by managing memory according to FIFO on a per-clip basis to ensure adequate buffering for gapless playback of a series of video clips. Further, the pipeline 1600 implementing such effective memory management allows for gapless playback to be rendered at the gaming console 10 (FIG. 1) or a mobile computing device—even without extra memory and/or software at the gaming console 10 or a mobile computing device. In addition, the pipeline 1600 may be implemented on a server, with or without a graphics card.

Returning to FIG. 15, the processor 18 (FIG. 1) renders not only a series of video clips, but also overlay data that enhances the video clips. The video clips may display a plurality of skill-based events as previously recorded (e.g., a plurality of soccer matches, football games, etc.); yet, such clips may alone not depict data directly related to an outcome of the VS game from the perspective of the user. For instance, a VS game score, which depends on the outcomes of a plurality of different events, is not displayed by the clips themselves.

Accordingly, in addition to receiving a compressed A/V clip, the processor 18 (FIG. 1) may also receive overlay data to be rendered in conjunction with a corresponding A/V clip. In one embodiment, the overlay data, which may be pertinent to the VS game and/or the events associated with the A/V clips themselves, are dynamic—changing throughout the VS game to pique the interest of the user. For example, the overlay data may include changing data such as team names, event location, etc. as the VS game seamlessly advances from one clip to the next. In an alternative embodiment, the overlay data is constant—persisting through at least a substantial portion, or possibly the entirety, of the VS game. For example, the overlay data may include a color scheme associated with a team that appears in all, or a substantial portion, of the video clips.

Further, an off-screen renderer 1505 renders the overlay data not present in the on-screen rendering of the plurality of clips 1601 illustrated in FIG. 16. In one embodiment, the off-screen render 1505 utilizes web browser code (e.g., HTML5) to generate a layout, and perform rendering, of the overlay data in conjunction with the plurality of video clips 1501. For example, the off-screen renderer 1505 may be an HTML5 renderer that instantiates a browser window in a memory device. A webpage appearing in the browser window may be configured to have a transparent background according to an alpha variable. In addition to conventional red, green, and blue (“RGB”) values, the alpha value is specific to transparency. As an example, a webpage with an alpha value of zero will be fully transparent.

The browser window generated by the off-screen renderer 1505 may be updated to display the overlay data and a transparent portion for the remaining area of the browser window intended for the portion of the video clip over which no overlay data is intended to be present. In other words, the browser window may be updated to perform synchronized rendering of particular overlay data in conjunction with playback of a corresponding video frame of one of the A/V clips 1601 illustrated in FIG. 3. Updates to the web browser window may be recorded as data blocks of blue, green, red, and alpha (“BGRA”) pixels in the memory device.

Further, in one embodiment, the array of BGRA pixels is represented as a video camera feed. For instance, a virtual camera 1506 may be configured to represent itself as a camera device to the operating system (e.g., via a device driver, native communications with the operating system, etc.). A plurality of variables (e.g., width, height, pixel format, color depth, etc.) may be associated with the virtual camera 206. After being initialized, the virtual camera may receive the overlay data as HTML5, or other browser code, frames. In other words, the off-screen renderer 1505 renders a web browser that is a camera feed for the virtual camera 1506.

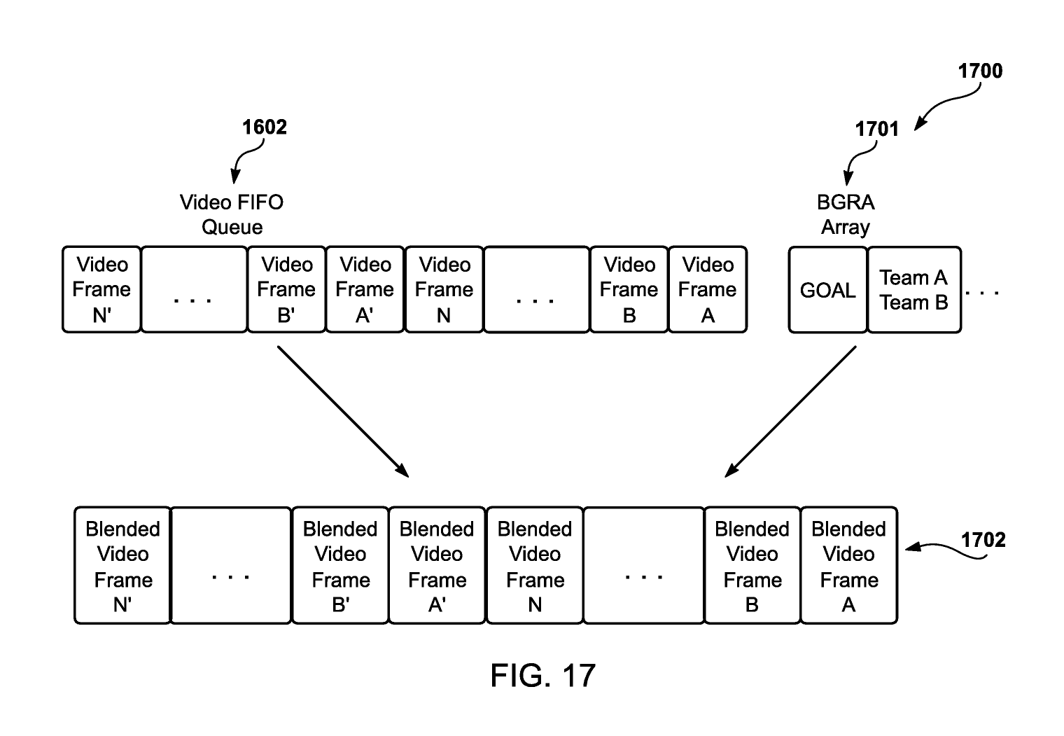

After isolating the decompressed video frames from the plurality of A/V clips 1601 into FIFO queues and capturing overlay data via the virtual camera 1506, the processor 18 invokes an alpha blender 1507 to blend the overlay data captured by the virtual camera 1506 over the video frames from the video FIFO queue 1602 (FIG. 16). As illustrated by a blending configuration 1700 in FIG. 17, the processor 18 (FIG. 1) reads data at a synchronized frame rate (e.g., a broadcast frame rate for playback) from the video FIFO 1702 and a BGRA array of pixels 1701. As a result, the processor 105 (FIGS. 1A and 1B) generates a blended video FIFO queue 1702 in which the HTML5 camera pixels are alpha blended onto the FIFO video frames.

Returning once again to FIG. 15, the alpha blender 1507 may blend video frames with overlay data in a synchronized manner utilizing a variety of different approaches. For example, the processor 18 (FIG. 1) may output the decompressed video frames 1601 into a different type of data structure other than a FIFO-based data structure or may render the overlay data via a configuration other than a web browser-based system.

In one embodiment, after the alpha blending is performed by the alpha blender 1507, the processor 18 (FIG. 1) invokes a re-multiplexer 1504 that re-multiplexes the de-multiplexed audio with the de-multiplexed, yet enhanced, video. The processor 18 (FIG. 1) reads the enhanced video frames from the alpha blender 1507, or the memory device, and the audio from the audio FIFO queue 1603. Further, the processor 18 invokes an encoder 1508 (e.g., MPEG encoder) to encode the re-multiplexed content into a compressed format that may be broadcasted to the user.

Accordingly, the processor 18 may invoke an output proxy 1509 that receives the compressed content encoded by the encoder 1508 (e.g., at a broadcast frame rate) and sends the compressed content to the user (e.g., at the broadcast frame rate) via one or more output systems (e.g., HTTP live streaming 1510, a streaming format 1511 sent to a content distribution network (“CDN”) for distribution to the user, a streaming format 1512 such as Real-Time Messaging Protocol (“RTMP”) sent to a streaming service, a direct link to a Serial Digital Interface (“SDI”) feed 1513 for satellite broadcast, local playback, a file writing service that saves video clips for subsequent broadcast, etc.).

In addition to the componentry illustrated in FIG. 15, various other components may be utilized to supplement the rendering of a VS game. For instance, prior to the processor 18 (FIG. 1) re-multiplexing the alpha-blended video with the original audio, the processor 18 may also invoke a picture-in-picture blender to blend overlay data as windows that are relatively small to a main window depicting the video frames of the original content. Such picture-in-picture windows may be specifically resized video clips or video clip files that are dynamically resized as necessary. In one embodiment, the picture-in-picture rendering is performed without alpha transparency (i.e., the pixels from the smaller video completely overwrite the background pixels of the larger video).

In another embodiment, audio may be obtained from a third-party source (e.g., a live commentary of a virtual event such as the VS game). In other words, audio in addition to the audio that is broadcasted from the original event may be utilized with any rendering pipeline described herein.

Although a single processor 18 is capable of performing the functionality described herein, multiple processors may be used instead. For example, a first processor may be utilized to implement the functionality of the game engine 188 (FIG. 13), and a second processor may be utilized to implement the functionality of the game client 184. For example, the first processor may implement functionality with respect to video clip sequence composition, including gapless playback attributes, and the second processor may implement functionality at the gaming console 10 for display the video clips and corresponding challenges.

A computer is herein intended to include any device that has a specialized, multi-purpose or single purpose processor as described above. For example, a computer may be a PC, laptop computer, set top box, cell phone, smartphone, tablet device, smart wearable device, portable media player, video player, etc.

It is understood that the apparatuses described herein may also be applied in other types of apparatuses. Those skilled in the art will appreciate that the various adaptations and modifications of the embodiments of the apparatuses described herein may be configured without departing from the scope and spirit of the present computer apparatuses. Therefore, it is to be understood that, within the scope of the appended claims, the present apparatuses may be practiced other than as specifically described herein.

We claim:

1. A virtual gaming console comprising:
a display device;
an input device that receives a session initiation input to initiate a virtual game and that receives a challenge response to a challenge presented during the virtual game that corresponds to the virtual game, the challenge being presented via the display device; and
a processor, in operable communication with a challenge database and a video clip database storing a plurality of prerecorded video clips of one or more real games, that initiates the virtual game based on the session initiation input, determines one or more virtual participants of the virtual game, determines a subset of the plurality of prerecorded video clips stored in the video clip database, allocate a threshold quantity of memory blocks to a buffer, randomly selects a plurality of virtual game clips from the subset, renders a gapless sequence of the plurality of virtual game clips on the display device, determines the challenge from the challenge database, renders the challenge on the display device, and determines an outcome to the challenge response, the threshold quantity of memory blocks being determined such that the processing speed of writing one or more frames of a video clip to the buffer is faster than a broadcast frame rate for broadcasting an additional video clip.

2. The virtual gaming console of claim 1, wherein the processor further determines a fixed maximum time for the display device to render the sequence of the plurality of virtual game clips.

3. The virtual gaming console of claim 2, wherein the processor performs the random selection of the plurality of virtual game clips based on the fixed maximum time until a total run time for the plurality of virtual game clips equals the fixed maximum time.

4. The virtual gaming console of claim 2, wherein the processor performs the random selection of the plurality of virtual game clips based on the fixed maximum time until a total run time for the plurality of virtual game clips equals the fixed maximum time.

5. The virtual gaming console of claim 1, wherein the processor further determines the challenge based on a virtual game clip in the sequence that has not yet been displayed by the display device.

6. The virtual gaming console of claim 1, wherein the processor further generates odds for the challenge.

7. The virtual gaming console of claim 1, wherein the virtual game is based on a sporting event.

8. The virtual gaming console of claim 1, wherein the processor communicates with the challenge database and the virtual clips database through a network.

9. The virtual gaming console of claim 1, wherein the threshold quantity of memory blocks is determined, at least in part, according to a size of a video frame.

10. The virtual gaming console of claim 9, wherein the size of the video frame is based on a quantity of pixels in the video frame.

11. The virtual gaming console of claim 10, wherein the threshold quantity of memory blocks is dynamically updated according to a change in the size of the video frame.

12. The virtual gaming console of claim 1, wherein the threshold quantity of memory blocks is determined, at least in part, according to a predetermined amount of time.

13. A computer program product comprising a non-transitory computer readable storage device having a computer readable program stored thereon, wherein the computer readable program when executed on a computer causes the computer to:
receive, with a processor, a session initiation input to initiate a virtual game, the processor being in operable communication with a challenge database and a video clip database storing a plurality of prerecorded video clips of one or more real games;
receive, with the processor, a challenge response to a challenge presented during the virtual game that corresponds to the virtual game, the challenge being presented via the display device;
initiate, with the processor, the virtual game based on the session initiation input;
determine, with the processor, one or more virtual participants of the virtual game;
determine, with the processor, a subset of the plurality of prerecorded video clips stored in the video clip database;
allocate, with the processor, a threshold quantity of memory blocks to a buffer;
randomly select, with the processor, a plurality of virtual game clips from the subset;
render, with the processor, a gapless sequence of the plurality of virtual game clips on a display device;
determine, with the processor, the challenge from the challenge database;
render, with the processor, the challenge on the display device; and
determine, with the processor, an outcome to the challenge response, the threshold quantity of memory blocks being determined such that the processing speed of writing one or more frames of a video clip to the buffer is faster than a broadcast frame rate for broadcasting an additional video clip.

14. The computer program product of claim 13, wherein the threshold quantity of memory blocks is determined, at least in part, according to a size of a video frame.

15. The computer program product of claim 13, wherein the processor further determines a fixed maximum time for the display device to render the sequence of the plurality of virtual game clips.

16. The computer program product of claim 15, wherein the processor performs the random selection of the plurality of virtual game clips based on the fixed maximum time until a total run time for the plurality of virtual game clips equals the fixed maximum time.

17. The computer program product of claim 13, wherein the processor performs the random selection of the plurality of virtual game clips based on the fixed maximum time until a total run time for the plurality of virtual game clips equals the fixed maximum time.

18. The computer program product of claim 13, wherein the processor further determines the challenge based on a virtual game clip in the sequence that has not yet been displayed by the display device.

19. The computer program product of claim 13, wherein the processor further generates odds for the challenge.

20. The computer program product of claim 13, wherein the virtual game is based on a sporting event.
